(19) United States
(12) Patent Application Publication
(10) Pub. No.: US 2009/0068458 A1
(43) Pub. Date: Mar. 12, 2009

(54) ADHESIVE-COATED BACKING FOR FLEXIBLE CIRCUIT

(75) Inventors: Rui Yang, Austin, TX (US); Jianhui Xia, Woodbury, MN (US); James R. Shirck, Austin, TX (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/851,149

(22) Filed: Sep. 6, 2007

(51) Int. Cl. B32B 7/12; B32B 38/10

(52) U.S. Cl. 428/354; 156/275.5

(57) ABSTRACT

The invention relates to adhesive coated backings used during fabrication of flexible circuits. The adhesive coatings exhibit high initial adhesion and a reduced level of adhesion after exposure to suitable radiation.

### FIELD OF THE INVENTION

The invention relates to adhesive coated backings used during fabrication of flexible circuits and more particularly to adhesive coatings having a reduced level of tack after exposure to suitable radiation.

### BACKGROUND

The production of flexible circuits requires a sequence of process steps in which a polymer substrate is typically passed through various deposition and etching stations. Conventional roll-to-roll processing of flexible circuits having thin polymer substrates can be difficult because the thin polymer can be too fragile to survive the manufacturing process. Although various types of stiffeners may be used, they must be removed at the end of the process. If a metal layer is applied on the back side of the flexible circuit as a stiffener, it typically must be etched away. If an adhesive-coated film is used, typically it must be peeled away from the thin polymer layer. This can result in adhesive being left on the thin polymer layer or damage to the circuit, such as stretching.

### SUMMARY

The present invention provides adhesive compositions suitable for coating on flexible circuit substrates to provide adhesive backings exhibiting relatively high initial adhesion. Exposure to suitable radiation induces curing of the adhesive backings, according to the present invention, to a condition having adhesion values significantly lower than an uncured adhesive. Reduction of adhesion, also referred to herein as adhesive detackification, at the end of the flexible circuit process allows the circuits to be removed without damaging them or leaving residual adhesive on the circuits.

High initial adhesion of UV detackifiable flexible circuit adhesive backings, according to the present invention, facilitates flexible circuit processing, especially in a roll-to-roll process. Controlled lowering of adhesion also facilitates circuit removal or pick from the adhesive coating by lowering the force required to remove individual circuits, circuit panels, or continuous sheets of circuits.

Adhesive compositions according to the present invention provide adhesive coated backings having initial adhesion levels sufficiently high for effective bonding to flexible circuits. A process of adhesive detackification uses ultraviolet radiation to crosslink an adhesive composition, to lower the level of adhesion or tack and thereby allows low force, clean removal of flexible circuits produced during the circuit-making process. The flexible circuits typically comprise a polyimide or liquid crystal polymer (LCP), but may be any polymer material to which the adhesive coated backing will have sufficiently high initial adhesion and sufficiently low adhesion after exposure to UV radiation. The polymer material need not be UV transmissive, but UV transmissibility would provide the option of exposing the adhesive to UV radiation from the top side of a circuitized substrate (recognizing that the circuit patterns would block UV radiation).

At least one aspect of the present invention provides an adhesive coated backing for supporting a flexible circuit during manufacture. The coated backing comprises a film substrate and a radiation detackifiable adhesive composition coated on a surface of the substrate. The adhesive composition may comprise a (meth)acrylate copolymer including from about 85 wt. % to about 97.5 wt. % of a (meth)acrylate ester and from about 2.5 wt. % to about 15 wt. % of a copolymerizable carboxylate monomer and a multi-functional urethane acrylate oligomer combined with the (meth)acrylate copolymer to provide from about 25 parts to about 40 parts of the oligomer per 100 parts of the copolymer. Preferably the (meth)acrylate copolymer consists essentially of from about 90 wt % to about 97.5 wt % of n-butyl acrylate and from about 2.5 wt % to 10 wt % of acrylic acid. The adhesive backing becomes progressively detackified during exposure to ultraviolet radiation. The adhesive backing preferably has an initial 180° peel adhesion from polyimide of about 28 g/25 mm (1 oz/in) or greater. The 180° peel adhesion falls to about 7 g/25 mm (0.25 oz/in) or lower after exposure of the coated backing to a 200-500 mJ UV lamp as needed. The exposure time needed will vary depending on the thickness of the adhesive layer and the energy output of the UV lamp.

### DEFINITION OF TERMS

The term “inherent viscosity” is described by the following equation wherein nsolvent is the viscosity of the solvent, nₛₒₗₙ is the viscosity of the solution and C is the solute concentration in terms of gm/deciliter or gm/100 mls which terms are equivalent:

Inherent viscosity (I.V.)=1nᵣ/C

nᵣ=nₛₒₗₙ/nₛₒₗᵥₑₙₜ

Use of the terms “detackification” or “detackifiable” refers to the downward change in adhesion occurring by exposure of adhesive backings of the present invention to selected radiation, usually ultraviolet (UV) radiation. The downward change during exposure produces less tacky adhesives.

The term multifunctional “urethane acrylate oligomer,” optionally replaced herein by the term “acrylated urethane oligomer,” refers to a material having multiple acrylate groups for rapid curing and development of very high-density crosslink network formation during exposure to suitable radiation in the presence of an initiator. The three basic components of a urethane acrylate oligomer include an isocyanate, an acrylate capping agent and a polyol backbone.

The term “(meth)acrylate,” used herein refers to either acrylate or methacrylate moieties.

The term “clean removal” refers to substantial elimination of adhesive contamination on the backside of flexible circuits removed from detackified adhesive coated backings circuit formation. Contamination may be revealed by differences in contact angle for clean substrate surfaces compared to substrate surfaces after contact with adhesive material. Contact angle differences of more than a few degrees suggest substrate surface contamination by adhesive residues.

The term “flexible substrate” refers generally to an article comprising a polymeric substrate and a patterned conductive circuit layer on the substrate.

### DETAILED DESCRIPTION

Adhesive backings, according to the present invention, comprise a flexible polymer film substrate coated with a detackifiable adhesive composition. Such adhesive backings may be used for reinforcing polymer substrates during flexible circuit manufacturing process.

Typically, the adhesive backing is adhered to the polymer or polymer/copper substrate during the initial steps of the circuit-making process. The opposite side of the adhesive backing may be adhered to a backing tape, preferably a UV-transmissive backing tape, or may be surface-treated to eliminate adhesive properties. The substrate may be in panel form or web form. The substrate is subjected to a number of different layer applications and treatments, depending on the desired flexible circuit. Examples of layer applications include conductive tie layers, conductive layers, adhesive layers, photoresist layers, etc. Examples of treatments include photoresist development, polymer etching, conductive layer etching, etc. In a roll-to-roll process, the web may be dispensed from a first roll, subjected to one or more layer application or treatment, and taken up on a second roll. For subsequent layer applications or treatments, the web may be dispensed from the second roll back onto the first roll or onto a third roll. Alternatively, the web may be first rewound onto the first roll then dispensed again from the first roll. In a panel process, individual panels are subjected to the same layer applications and treatments as the web.

Adhesive compositions suitable for the adhesive backings according to the present invention comprise acrylate copolymers having a molecular weight or at least about 200,000 mixed with multifunctional acrylate oligomers. The oligomers provide the initial tack levels which are lowered by exposure of the adhesive compositions to suitable radiation. Adhesive compositions may be applied, using conventional methods of coating, preferably transfer-coating, to backings to produce the adhesive coated backings of the present invention. While not wishing to be bound by theory, it is believed that improvement of the miscibility of the components enhances compositional uniformity and morphological stability of the adhesive to minimize phase separation of adhesive reaction products before and after exposure to crosslinking radiation. In this invention the miscibility of acrylate copolymers and urethane acrylate oligomers improves by adjustment of the amount of an acid monomer comprising an acrylate polymer having an inherent viscosity of from about 1.5 to about 1.6 corresponding to a relatively high molecular weight of about 400,000. This produced an adhesive for use with radiation transmissible, in particular, UV transmissible, backing materials to yield flexible circuit backings that may be detackified during exposure to ultraviolet radiation.

Desirable properties for substrate polymer films include, dimensional stability, i.e. substantial uniformity of stress/strain in both machine and cross directions, puncture resistance, and UV transmissibility. The substrate polymer film may optionally be transparent. Substrates for coating with adhesive compositions according to the present invention may be any material conventionally used as a tape backing, optical film or any other flexible material including single layer, multilayer, and multiaxially oriented films. Suitable film substrate materials include polyesters, such as polyester terephthalate (PET) and polyester naphthalate (PEN), polycarbonate (PC), and polypropylene (PP). Also suitable are copolymers of ethylene with alpha-olefin monomers such as octene and hexene, ethylene vinyl acetate copolymers, ethylene methyl acrylate copolymers, and films of SURLYN polymers that are available from du Pont de Nemours and Company. SURLYN is an ionomer formed from copolymers of ethylene and a salt of (meth)acrylic acid. Materials of this type are preferably dimensionally stable and tough films having a thickness from about 50 μm to about 125 μm.

Adhesive compositions according to the present invention are preferably radiation sensitive formulations having high adhesion initially and significantly lower adhesion following exposure to suitable radiation. Adhesion levels associated with these adhesive compositions may be lowered in a controlled manner by exposure to ultraviolet (UV) radiation. Suitable adhesive compositions retain required levels of adhesion during the flexible circuit manufacturing process, which may expose the adhesive to harsh elements such as water, copper plating solutions, copper and polymer etchants, and elevated temperatures up to about 100° C. Backings coated with adhesive compositions according to the present invention, therefore, possess high initial adhesion that diminishes with exposure to suitable radiation. Also the adhesive coated backings may be substantially transparent if clear adhesive compositions, preferably based upon acrylate polymers, are used with clear substrates. Bond strength is important for supporting the flexible circuit substrate during circuit formation, so the adhesive needs to adequately bond to the flexible circuit substrate.

Adhesive compositions suitable for adhesive backings according to the present invention may comprise homopolymers of (meth)acrylate ester monomers and copolymers of such esters with (meth)acrylic acid monomers. (Meth)acrylate ester monomers include monofunctional acrylate or methacrylate esters of non-tertiary alkyl alcohols, and mixtures thereof. Preferred monomers include methyl acrylate, ethyl acrylate, propyl acrylate, n-butyl acrylate, isobutyl acrylate, 2-methylbutyl acrylate, 2-ethylhexyl acrylate, 2-ethylhexyl methacrylate, n-octyl acrylate, n-octyl methacrylate, isooctyl acrylate, isooctyl methacrylate, isononyl acrylate, isodecyl acrylate, isobornyl acrylate, isobornyl methacrylate, vinyl acetate, and mixtures thereof. (Meth)acrylic acid monomers include acrylic acid, methacrylic acid, beta-carboxyethyl acrylate, itaconic acid, crotonic acid, fumaric acid, and the like incorporated into a copolymer at an acidic monomer concentration of from about 2.5 to about 15 weight percent.

The properties of (meth)acrylate ester/(meth)acrylic acid copolymers vary as a result of mixing them, e.g., with multifunctional urethane acrylate oligomers. A versatile array of acrylated urethane oligomers exists to satisfy a broad range of applications. Properties of these materials may be varied depending upon selection of the type of isocyanate, the type of polyol modifier, the reactive functionality and molecular weight. Diisocyanates are widely used in urethane acrylate synthesis and can be divided into aromatic and aliphatic diisocyanates. Aromatic diisocyanates are used for manufacture of aromatic urethane acrylates which have significantly lower cost than aliphatic urethane acrylates but tend to noticeably yellow on white or light colored substrates. Aliphatic urethane acrylates include aliphatic diisocyanates that exhibit slightly more flexibility than aromatic urethane acrylates that include the same functionality, a similar polyol modifier and at similar molecular weight. Preferred urethane acrylates include reactive, multifunctional oligomers such as a hexafunctional aromatic urethane acrylate available as CN-975 (M. Wt. is approx. 800) from Sartomer Company of Exton, Pa., and EBECRYL resins available from UCB, Belgium and including EBECRYL 220 (M. Wt. is approx. 1000), a prepolymer based upon acrylic acid, an aliphatic unsaturated polyester and an aromatic isocyanate, and EBECRYL 8301 (M. Wt. is approx. 1000), a hexafunctional aliphatic urethane acrylate containing an acrylated polyol diluent.

Miscibility of components may prevent phase separation that causes haze. Interaction between the acrylate polymer and the acrylated urethane oligomer, to improve physical or chemical compatibility should increase light transmittance and lower the haze of a composition. Adhesive component miscibility may also affect adhesive transfer to the surface, i.e., backside, of the flexible circuit. Higher miscibility typically provides less adhesive transfer. Radiation sensitive adhesive compositions according to the present invention provide substantially non-contaminating supporting backings.

The acrylic acid component of the acrylate copolymer appears to affect the adhesion of adhesive coated backings according to the present invention. Adhesion for compositions containing copolymers of n-butyl acrylate and acrylic acid, before exposure to UV, may be less than typically desired for copolymers containing over 98 parts of n-butyl acrylate to less than 2 parts of acrylic acid. Exposure to suitable radiation, including UV radiation, lowers adhesion due to crosslinking of the hexafunctional urethane acrylate oligomer.

Crosslinkers such as 1,1′-isophthaloylbis(2-methylaziridine) may be added to promote crosslinking of free acid groups to control modulus and improve the shear adhesion level of the adhesive before exposure to suitable radiation. Suitable materials for initiating free radical crosslinking to reduce adhesion include benzophenone, benzoin, benzoin ethers, acylphosphine oxides, thioxanthone derivatives, α,α,dialkoxyacetophenones, α-hydroxy alkyl phenones and benzil ketals. Preferred initiators are commercially available as e.g. DAROCURE 1173 and IRGACURE 651 (available from Ciba Specialty Chemicals Inc. of Tarrytown, N.Y.).

Solution adhesives may be coated onto suitable substrates by any variety of conventional coating techniques such as roll coating, spray coating, knife coating, and die coating. Also, any of these methods may be used to coat an adhesive composition onto a suitable release liner for transfer by lamination to a selected backing.

### EXAMPLES

### Example 1 and Comparative Example A

Both Example 1 and Comparative Example A are made by roll-to-roll processes.

An adhesive was prepared as a solution in acetone. The following composition is given in parts per 100 parts of acrylate copolymer after removal of solvent. The adhesive had the following composition: (1) an acrylate copolymer with a monomer ratio of 90 wt % n-butyl acrylate and 10 wt % acrylate acid; (2) 30 parts of a urethane acrylate (molecular weight about 800) available under the trade designation CN 975 from Sartomer Company, Exton, Pa.; (3) 1.5 parts of a photoinitiator available under the trade designation DAROCUR 1173 from Ciba Specialty Chemicals Inc.; and (4) 0.15 parts of a 1,1′-isophthaloylbis(2-methylaziridine crosslinker. The photoinitiator and crosslinker were added just before coating. Following the addition of the solute materials, the solids content of the solution was adjusted to 25 wt % with acetone and the resulting composition was mixed thoroughly. The adhesive was knife coated to a thickness of about 10-12 microns on a 2 mil (50.8 micron) PET film. The adhesive-coated PET was dried in an oven at about 60° C. for about 1-2 minutes. The adhesive-coated PET was laminated to a 1 mil (25.4 micron) KAPTON E polyimide film, available from DuPont, using a standard laminator at room temperature with hand pressure. A tie layer of 50 Å (5 nm) thick Chromium, then a seed layer of 1500 Å (150 nm) thick copper are sputtered on to the KAPTON E film. Copper is then plated on the seed layer to a thickness of about 8 micrometers. A dry film photoresist, available under the trade designation KG 2150 from Kolon Industries, Korea, was then laminated onto the copper side. The photoresist was then exposed to UV light through a photomask to form a desired pattern of cross-linked photoresist. The uncrosslinked photoresist was then developed using a 2-3% sodium carbonate solution to expose portions of the copper layer. The exposed copper was then etched using a cupric chloride solution to form the desired circuit pattern. The crosslinked photoresist was then stripped using a dilute 4% KOH solution. The adhesive-coated PET was exposed to 400 mJ/cm² using a 300-380 nm UV exposer, commercially available from Fusion Systems, Rockville, Md., for about 10 seconds in a closed chamber with the exposer within about 6 inches of the PET film. Afterward, the adhesive-coated PET was peeled from the KAPTON E film at about a 180 degree angle.

Comparative Example A was a KAPTON E film having a patterned copper layer, made in a manner similar to that of Example 1 except that no adhesive-coated backing was applied.

The circuit dimension movement measurements of Example 1 and Comparative Example A were measured in the web (down web) and transverse web (cross web) directions. Sample circuitized web material was left in a room containing a custom made web tension simulator for 24 hours to adjust the room temperature and the room's humidity level, which was about 60%. After the 24 hours, reference points on the circuitized web were selected as fiducials. Using a microscope, initial measurements were taken to determine the initial distance between two sets of fiducials in both the down web and transverse web directions. A 4 foot long section of the sample was attached to the web tension simulator. The web tension simulator had a vertical support pole from which two parallel clamps extended horizontally. The clamps could be adjusted to be separated by 3 to 5 feet. The 4 foot long sample was secured between the clamps. Weights were then attached to the bottom clamp to simulate web tension. An initial measurement of the tension was taken. The tension was recorded in pounds per linear inch (PLI). After 2 hours, the sample was removed from the simulator and a second set of measurements were taken. The sample was then again secured between the clamps. After a total of 5 hours, the sample was again removed from the simulator and a third set of measurements were taken. The results for the two sets of fiducials were averaged for each measurement taken (initial, 2 hour, 5 hour). The percentages of movement are shown in the table below. The percentages do not indicate the direction of movement, only the absolute value of the movement measurement.

| | | | Fiducial | |
|---|---|---|---|---|
| Sub- | Fiducial Movement in Down | | Movement in Transverse | |
| strate | Web Direction (%) | | Web Direction (%) | |
| | 1 PLI and 2 hr | 1 PLI and 5 hr | 1 PLI and 2 hr | 1 PLI and 5 |
| | tension | tension | tension | hr tension |
| CE. A | 0.85 | 0.90 | 0.01 | 0.08 |
| EX. 1 | 0.26 | 0.31 | 0.01 | 0.00 |
| | 2 PLI and 2 hr | 2 PLI and 5 hr | 2 PLI and 2 hr | 2 PLI and 5 |
| | tension | tension | tension | hr tension |
| CE. A | 1.11 | 1.28 | 0.30 | 1.27 |
| EX. 1 | 0.40 | 0.43 | 0.01 | 0.03 |
| | 5 PLI and 2 hr | 5 PLI and 5 hr | 5 PLI and 2 hr | 5 PLI and 5 |
| | tension | tension | tension | hr tension |
| CE. A | 3.15 | 4.41 | 0.76 | 1.02 |
| EX. 1 | 1.02 | 1.15 | 0.33 | 0.45 |

Adhesive compositions suitable for coating on substrates to provide radiation detackifiable adhesive backings for making flexible circuits, the adhesives exhibiting relatively high initial adhesion, have been described according to the present invention. It will be appreciated by those of skill in the art that, in light of the present disclosure, changes may be made to the embodiments disclosed herein without departing from the spirit and scope of the invention.

What is claimed is:

1. An article comprising:
an ultraviolet radiation transmissible substrate;
a radiation detackifiable adhesive composition applied on a surface of said substrate, said adhesive composition capable of becoming progressively detackified during exposure to ultraviolet radiation; and
a flexible circuit substrate on the adhesive-coated substrate.

2. The article of claim 1 wherein said adhesive composition comprising: a (meth) acrylate copolymer including from about 85 wt % to about 97.5 wt. % of a (meth)acrylate ester and from about 2.5 wt. % to about 15 wt. % of a copolymerizable carboxylate monomer; and a multi-functional urethane acrylate oligomer combined with said (meth)acrylate copolymer to provide from about 25 parts to about 40 parts of said oligomer per 100 parts of said copolymer.

3. The article of claim 2 wherein said (meth)acrylate ester is selected from the group consisting of methyl acrylate, ethyl acrylate, propyl acrylate, n-butyl acrylate, isobutyl acrylate, 2-methylbutyl acrylate, 2-ethylhexyl acrylate, 2-ethylhexyl methacrylate, n-octyl acrylate, n-octyl methacrylate, isooctyl acrylate, isooctyl methacrylate, isononyl acrylate, isodecyl acrylate, isobomyl acrylate, vinyl acetate and mixtures thereof.

4. The article of claim 2 wherein said copolymerizable carboxylate monomer is selected from the group consisting of acrylic acid, methacrylic acid, beta-carboxyethyl acrylate, itaconic acid, crotonic acid, and fumaric acid.

5. The article of claim 2 wherein said (meth)acrylate copolymer consists essentially of from about 90 wt % to about 97.5 wt % of n-butyl acrylate and from about 2.5 wt % to 10 wt % of acrylic acid.

6. The article of claim 1 wherein said adhesive coated backing has an initial 180° peel adhesion to polyimide of about 28 g/25 mm or greater, said 180° peel adhesion falling to about 7 g/25 mm or lower after exposure of said coated backing to an effective amount of UV radiation.

7. The article of claim 2 wherein said multi-functional urethane acrylate is an aliphatic urethane acrylate oligomer.

8. The article of claim 2 wherein said multi-functional urethane acrylate is an aromatic urethane acrylate oligomer.

9. The article of claim 3 wherein said multi-functional urethane acrylate is hexafunctional aromatic urethane acrylate oligomer.

10. The article of claim 2 wherein said (meth)acrylate copolymer has a molecular weight of at least about 200,000.

11. The article of claim 1 wherein said film substrate is selected from the group consisting of polyester terephthalate, polyester naphthalate, polycarbonate, polypropylene, copolymers of ethylene with octene and hexene, ethylene vinyl acetate copolymers, ethylene methyl acrylate copolymers, and ionomer films.

12. The article of claim 1 wherein said film substrate is multiaxially oriented.

13. The article of claim 1 wherein the flexible circuit substrate is polyimide.

14. A method of making a flexible circuit comprising:
providing an ultraviolet radiation transmissible substrate;
applying a radiation detackifiable adhesive composition on a surface of said substrate, said adhesive composition capable of becoming progressively detackified during exposure to ultraviolet radiation to form a flexible circuit backing;
attaching a flexible circuit substrate on the adhesive-coated substrate;
forming a patterned conductive circuit layer on the flexible circuit substrate;
exposing the radiation detackifiable adhesive to ultraviolet light through the radiation transmissible substrate; and
removing the flexible circuit backing from the flexible circuit.

15. The method of claim 14 wherein the method is a roll-to-roll process.

16. The method of claim 14 wherein the method is a panel process.
